(19) United States
(12) Patent Application Publication
(10) Pub. No.: US 2009/0279187 A1
(43) Pub. Date: Nov. 12, 2009

(54) Optical zoom system with voice coil motors

(76) Inventor: Chuo-Han Tsai, Hsinchu (TW)

Correspondence Address: ROSENBERG, KLEIN & LEE, 3458 ELLICOTT CENTER DRIVE-SUITE 101, ELLICOTT CITY, MD, 21043, US

(21) Appl. No.: 12/149,974

(22) Filed: May 12, 2008

(51) Int. Cl. G02B 15/14

(52) U.S. Cl. 359/698

(57) ABSTRACT

An optical zoom system uses voice coil motors to drive zoom lens sets moving along an optical axis for the control of forming image and focusing. Voice coil motors of the system move respectively two zoom lens sets to the first position and the second position on the optical axis to control the image formation and to adjust the imaging distance. The first position and the second position are predetermined and recorded in a zoom database.

### BACKGROUND OF THE INVENTION

1. Field of the Invention

The present invention relates to an optical zoom system, which, more particularly, uses voice coil motors to move the zoom lens sets.

2. Description of the Prior Art

An optical zoom system adjusts the imaging distance and magnification of the image via controlling two or more zoom lens sets.

FIG. 1 shows an optical zoom system 10 applied in cameras. The optical zoom system 10 uses the step motor 16 to drive a gear set 18 to drive a camber screw rod 14. Consequently, the zoom lens sets 12a, 12b are moved and adjust the image formation and imaging distance of the optical zoom system 10.

This art requires the precise camber screw rod 14 to deliver the twisting force of the step motor 16, so it has disadvantages of high power-consumption, noise and high cost.

### SUMMARY OF THE INVENTION

One objective of the present invention is to provide an optical zoom system, which uses voice coil motors to drive the zoom lens sets moving to the predetermined positions to control the image formation and adjusts the imaging distance based on a predetermined zoom database.

An optical zoom system with voice coil motors according to one embodiment of the present invention includes a first lens set and a second lens set, a first voice coil motor and a second voice coil motor, a zoom database, and a control module.

The control module reads position information of a first lens set and a second lens set from the zoom database, and drives the first voice coil motor and second voice coil motor to move the first lens set and the second lens set respectively along an optical axis to control the image formation and adjust the imaging distance.

Other advantages of the present invention will become apparent from the following description taken in conjunction with the accompanying drawings, which are set forth by way of illustration and example, to certainly embody the present invention.

### BRIEF DESCRIPTION OF THE DRAWINGS

The foregoing aspects and many of the accompanying advantages of this invention will become more readily appreciated as the same becomes better understood by reference to the following detailed description, when taken in conjunction with the accompanying drawings, wherein:

FIG. 1 is a schematic diagram showing the mechanism of an optical zoom system using step motors according to an prior art.

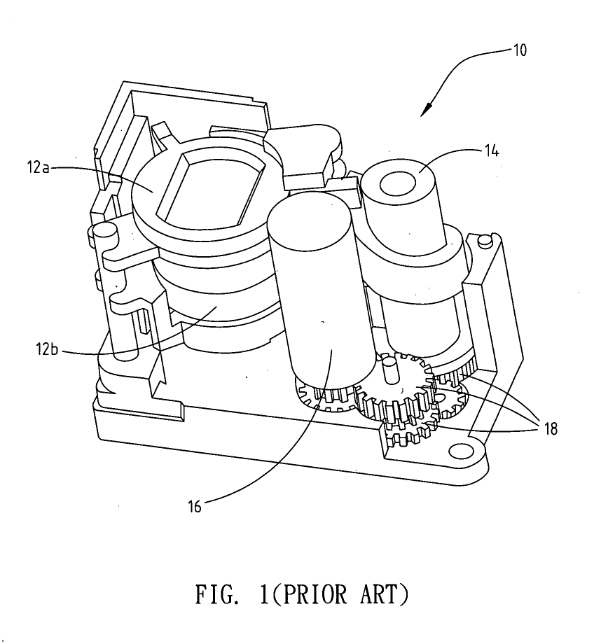

FIG. 2 is a schematic diagram showing an optical zoom system using voice coil motors according to an embodiment of the present invention.

FIG. 3 is a schematic diagram showing the zoom database according to an embodiment of the present invention.

### DESCRIPTION OF THE PREFERRED EMBODIMENT

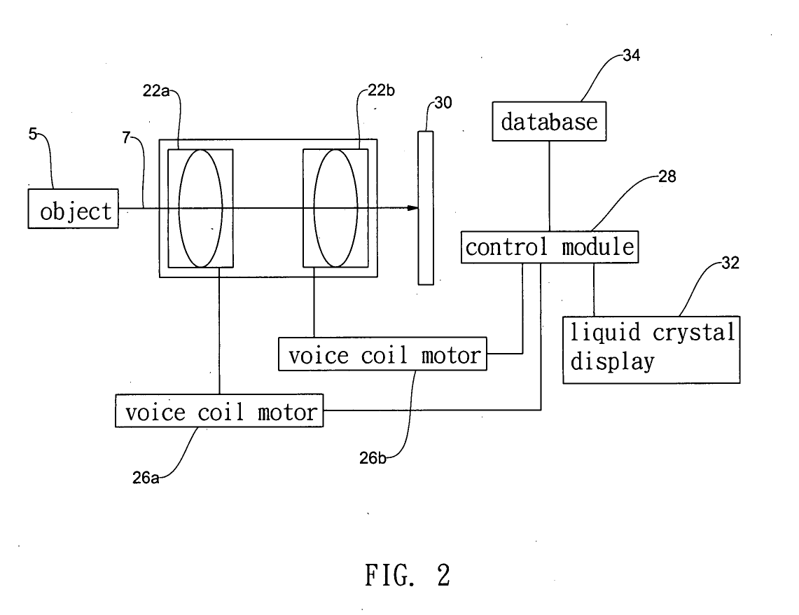

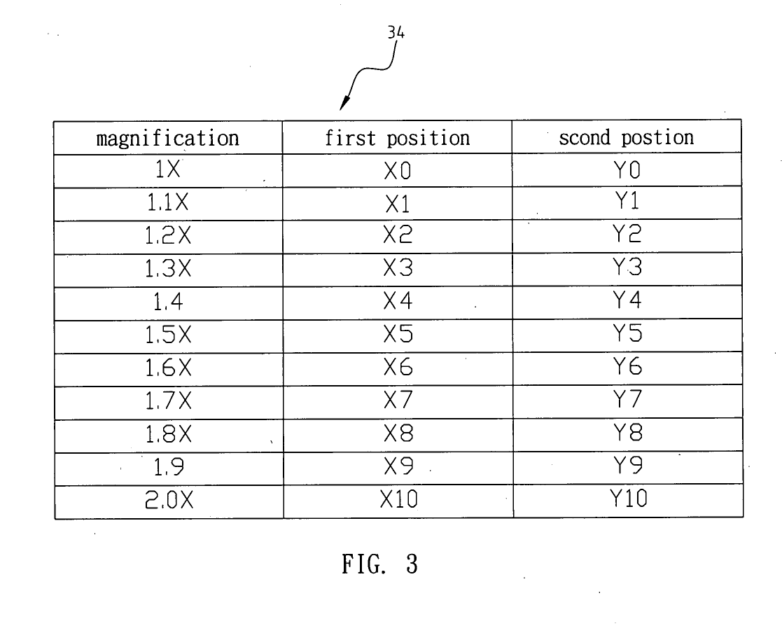

FIG. 2 shows an optical zoom system with voice coil motors according to one embodiment of the present invention, wherein the zoom database 34 is shown in FIG. 3.

As shown in FIG. 2, the optical zoom system 20 includes a zoom database 34, a control module 28, a first voice coil motor 26a, a second voice coil motor 26b, a first lens set 22a, and a second lens set 22b.

The light from an object 5 enters the image formation system along an optical axis 7, and the image of the object forms on an optical sensor 30 via the first lens set 22a and the second lens set 22b. The image may be viewed on a liquid crystal display (LCD) module 32. The magnification and imaging distance of the image formed on the optical sensor 30 is determined by the positions and relative distance of the first lens set 22a and second lens set 22b. In general, one or more guiding steel axes are utilized to control the movement of the first lens set 22a and second lens set 22b along the optical axis 7.

The control module 28 of the optical zoom system 20 reads the position information of lens sets from the zoom database 34. Then the control module 28 drives the first voice coil motor 26a and second voice coil motor 26b to move the first lens set 22a and second lens set 22b along the optical axis 7 to the assigned position, without requiring a camber screw rod. Consequently, the first lens set 22a and second lens set 22b form the image on the optical sensor 30. When users adjust the image size, the control module 28 reads the position information of lens sets from the zoom database 34 and moves the first lens set 22a and second lens set 22b along the optical axis 7 to the new assigned position to achieve the function of zooming or adjusting image magnification.

For example, when users choose 1.3× (1.3 times) as the magnification, the control module 28 reads the position information with X3 as the first position and Y3 as the second position from the zoom database 34, then drives the first voice coil motor 26a and the second voice coil motor 26b respectively, and consequently zooms in or out the image.

Above-mentioned lens sets 22a and 22b may include a single lens or optical components composed of multiple lenses, and the optical sensor 30 may be CMOS (complementary metal-oxide-semiconductor) or CCD (Charge-coupled device).

While the invention is susceptible to various modifications and alternative forms, a specific example thereof has been shown in the drawings and is herein described in detail. It should be understood, however, that the invention is not to be limited to the particular form disclosed, but to the contrary, the invention is to cover all modifications, equivalents, and alternatives falling within the spirit and scope of the appended claims.

1. An optical zoom system with voice coil motors, applied in a camera, comprising:
a first lens set and a second lens set;
a first voice coil motor and a second voice coil motor respectively connected to the first lens set and the second lens set;
a zoom database configured to store relationships between a magnification and a position information of the first lens set and the second lens set; and
a control module, wherein the control module reads the position information of the first lens set and the second lens set from the zoom database according to a selected magnification and drives the first voice coil motor and the second voice coil motor to move the first lens set and second lens set along an optical axis.

2. The optical zoom system of claim 1, wherein any one of the first lens set and the second lens set comprises a single lens or an optical component consisted of multiple lenses.

3. The optical zoom system of claim 1 or 2, further comprising one or more guiding steel axes, wherein the guiding steel axes are utilized to constrain the first lens set and the second lens set moving along the optical axis.

4. The optical zoom system of claim 1, further comprising an optical sensor, wherein the optical sensor is used to sense the image focused by the first lens set and the second lens set.

5. The optical zoom system of claim 4, further comprising a liquid crystal display (LCD) module, wherein the liquid crystal display module is used to view the image on the optical sensor.
